(19) United States
(12) Patent Application Publication
(10) Pub. No.: US 2011/0040740 A1
(43) Pub. Date: Feb. 17, 2011

(54) SEARCH ENGINE UTILIZING FLOW NETWORKS

(76) Inventor: Alex Nugent, Santa Fe, NM (US)

Correspondence Address: ORTIZ & LOPEZ, PLLC, P.O. Box 4484, Albuquerque, NM, 87196-4484, US

(21) Appl. No.: 12/848,613

(22) Filed: Aug. 2, 2010

Related U.S. Application Data
(60) Provisional application No. 61/234,287, filed on Aug. 15, 2009.

(51) Int. Cl. G06F 17/30

(52) U.S. Cl. 707/706; 707/726; 707/E17.108

(57) ABSTRACT

A system and method for searching resources is disclosed. Each resource is associated with one or more pictograms. The pictorial questions (pictions) are created by searching a network of pictions and displaying associated pictograms. The selections of pictograms define a path of linked resources. The resource paths are computed as flows and used to update resource network connections. A user's prior selection(s) of resources are used as flow sources for result ordering. The ratio of the number of times the pictogram was displayed versus the number of times it was clicked rates can be utilized as selection criteria in an evolutionary algorithm to optimize pictograms. The disclosed system and method can also display local goods and services through a kiosk.

### CROSS-REFERENCE TO PROVISIONAL APPLICATION

This application claims priority to U.S. Provisional Patent Application Ser. No. 61/234,287, which was filed on Aug. 15, 2009, the disclosure of which is incorporated herein by reference in its entirety.

### TECHNICAL FIELD

Embodiments are generally related to searching and retrieval of data. Embodiments also relate to search engines. Embodiments additionally relate to techniques and systems for reaching resources through computer networks, computers, mobile computing devices, websites, and electronic kiosks.

### BACKGROUND

The World Wide Web (WWW) referred as “web” contains a vast amount of information. Locating a desired portion of the information, however, can be challenging because of the increasing amount of information on the web and most of the information is image based.

Search engines attempt to return hyperlinks that point to the web pages that are related to a users search query, which is specified as a text string. Based on the search query, the goal of the search engine is to provide links of high quality and relevant web resources. Typically, a conventional search engine matches the terms in the search query to a set of pre-stored web pages and further ordering the results based on a ranking system. Web pages containing the user's search terms, referred as “hits” and are returned to the user.

To build complex queries, almost every search engine uses a query language. With the help of logical (Boolean) operations, a user can point out the words to be present (or absent) in the required document, show how far apart the words can be from each other, enumerate synonyms, and identify possible unwanted words in the required document. Unfortunately the query language requires special knowledge which makes the language practically inaccessible by the lay users. Therefore, all search engines use an extra page, hidden behind the main search page.

Conventional search engines also use the standard concept of a command line to type in a query, and return a number of hyperlinks as the search result. One of the problems in modern search engine development is being able to present information to the user in the most intuitive manner. Currently, conventional systems, in response to a user query, display a list of links to websites that the search engine considers relevant. Generally, the ordering of the links in the display is indicative of greater or lesser relevance of the particular search result, based on some algorithm utilized by the search engine to assess the relevance of a particular webpage. Also, conventional search engines can display small excerpts from the text on the websites, typically the text that is found close to the query terms. This assists the user in quickly estimating whether the text (and, presumably, the entire website to which the hyperlink points) is more or less relevant to the required search results.

One difficulty is, considerable burden placed on the user to read significant amount of text in the link and high mental effort needed to sort through the results provided by the search engine. Even in the case where the most relevant search result is close to the top of the ranking, nonetheless, some effort and time by the user is necessary to read the text of the annotations provided by the search engine.

Another difficulty, which is not addressed by any of the current search engines, is the problem of pointing a user to web resources in the case where the user does not know the search name, or cannot specify as a search string. This is perhaps the most severe limitation of prior art search engines, such as, for example, the well known Google® search engine and related applications.

In modern search engines, the user enters the search keywords and the corresponding results are displayed. The search engines do not provide the required results, when the user does not know the keyword to be used in the search. In fact, when the user searches for new things to do or buy with current searching technologies, the results are inevitably concepts that the user already knows about and to which the user can attach a keyword. In most cases, when the user does not know what exactly is needed, search is an arduous process that involves thinking of particular keywords, visually identifying what is retrieved, modifying the keywords, and repeating. Most often, the user is unable to find the exact search result. During searching, the user may not be in a position to recall the known search string or may not have the idea of the search string. However, the user may be in need of some search results and if some options are given, the user can usually state clearly what the he or she like, dislike and even in what order the he or she like and dislike them.

Most people are familiar with the game “twenty questions”. In this game one player thinks of anything in the known universe while other players ask questions with “yes”, “no”, “maybe” or “unknown” answers. Usually with only twenty questions, a skilled questioner can reduce the space of all possible entities to only one, at which point the questioner will have won the game. The questions can be asked in a special order whereby half, or approximately half, of the possibilities are eliminated with each question. Thus, the game utilizes the power of exponentials. In the ideal case where each question has a yes/no answer, 20 questions can search a space of over 1 million possibilities. If a question could be formed such that it could be answered by picking 9 alternatives, 20 questions could reduce the space of 1.2E19 possibilities. Or, stated another way, only 9 questions would be needed to reduce the space of over 1 billion options, 8 questions for a space of 43 million, 7 questions for a space of 4.7 million, etc. As a practical example, suppose that a tourist destination contained 1,000 merchants, where each merchant offered on average 500 products, for a total space of 500,000 products. With 6 carefully crafted “questions”, the user could find what they were looking for or something they liked.

Modern search engines such as Google® or Yahoo® or Bing™ follow the paradigm of finding internet resources by responding to the user's questions or keywords. That is, the answer follows from the question, which must be provided by the user. The disclosed embodiments utilize an innovative process whereby a series of questions are utilized to determine the answer. The invention is not particularly useful when the user knows exactly what he or she wants, but is very useful in the case where the user does not know what he or she is searching for.

As an example, consider shopping for women's shoes. Shoes or items do not simply relate to covering the women's foot, instead the items are related to fashion and the woman's notions of what the user likes or dislikes. The needed item should not be the one that user already has and not be a brand that user does not like, etc. In such a case, the user may know the item when it was seen but may not be able to describe in words what the user wants. Examples abound, from internet shopping to brick and mortar stores, online dating services, and so forth. The present invention uses a method of questioning the user in the form of pictograms, instead of requesting for a search string.

### BRIEF SUMMARY

The following summary of the invention is provided to facilitate an understanding of some of the innovative features unique to the present invention, and is not intended to be a full description. A full appreciation of the various aspects of the invention can be gained by taking the entire specification, claims, drawings, and abstract as a whole.

It is, therefore, one aspect of the present invention to provide for an improved search engine.

It is still another aspect of the present invention to provide for a search engine based on user-interaction with graphically displayed pictions as defined herein.

It is a further aspect of the present invention to provide for a web-based search engine.

It is another aspect of the present invention to provide for a search engine accessible through an electronic kiosk.

The nature of modern search engine is the problem of forming questions. Since the user may not know how to describe in words what he or she is searching for, or may not even know what he or she wants it is not sufficient to use words as a means to ask a question. Rather, pictures or images must be used as questions. The use of pictures or images has the advantage of bypassing language and making the system available to people of all languages. The question should be simply a choice among options. Thus, formulating a question that is a matter of having the user select among a set of pictures (e.g., a picture of a tree, a dog and a rock) can be referred to as a “pictorial question” or, as referred to herein, a “piction”. The common wisdom is that showing a juxtaposition of pictures requires that the system “know” what is in the picture. This common wisdom is incorrect. In fact, the system can be made to organize itself to optimize its ability to ask pictorial questions without any knowledge of what the picture(s) contain.

The above and other aspects can be achieved as will now be described. A system and method for searching resources, wherein one or more pictograms are associated with each resource. The pictions are created by searching a network of pictions and displaying associated pictograms. The selections of pictograms define a path of linked resources. The resource paths are computed as flows and used to update resource network connections. A user's prior selection(s) of resources are used as flow sources for result ordering. “Click-through” rates can be utilized as selection criteria in an evolutionary algorithm to optimize pictograms. The disclosed system and method can also display local goods and services through a kiosk.

### BRIEF DESCRIPTION OF THE DRAWINGS

The accompanying figures, in which like reference numerals refer to identical or functionally-similar elements throughout the separate views and which are incorporated in and form part of the specification, further illustrate the present invention and, together with the detailed description of the invention, serve to explain the principles of the present invention.

FIG. 1 illustrates a schematic diagram of an example hierarchical router tree 100, in accordance with an embodiment;

FIG. 2A illustrates a schematic diagram of a system including two subgraphs, in accordance with an embodiment;

FIG. 2B illustrates a schematic diagram of a system including two subgraphs, in accordance with an embodiment;

FIG. 3 illustrates a schematic diagram of a piction, in accordance with an embodiment;

FIG. 4 illustrates a schematic diagram of a system depicted as one particular resource network including network weights, user paths and user target selections, in accordance with an embodiment;

FIG. 5 illustrates a schematic diagram of a user path including network selection, target selection, and flow values used for network update;

FIG. 6 illustrates a schematic diagram of a search bias method utilizing flow activation computed using the users path as flow sources;

FIG. 7 illustrates a schematic diagram of a Graphical User Interface (GUI) allowing user likes and dislikes, in accordance with an embodiment;

FIG. 8 illustrates an example of a graphical user interface, which may be utilized in accordance with one or more embodiments;

FIG. 9 illustrates an exemplary computer system, wherein an embodiment may be implemented;

FIG. 10 illustrates a block diagram of an exemplary communications system, which may be utilized to implement an embodiment;

FIG. 11 illustrates a graphically displayed search engine which a user may access to search based on graphically displayed images in accordance with an embodiment;

FIG. 12 illustrates a flow chart of operations depicting logical operational steps of a search engine method, in accordance with an embodiment.

FIGS. 13-14 illustrate examples of interactive electronic kiosks in which embodiments may be implemented; and

FIG. 15 illustrates a flow chart of operations depicting logical operations of a method authorizing access to the disclosed search engine, in accordance with an embodiment.

### DETAILED DESCRIPTION

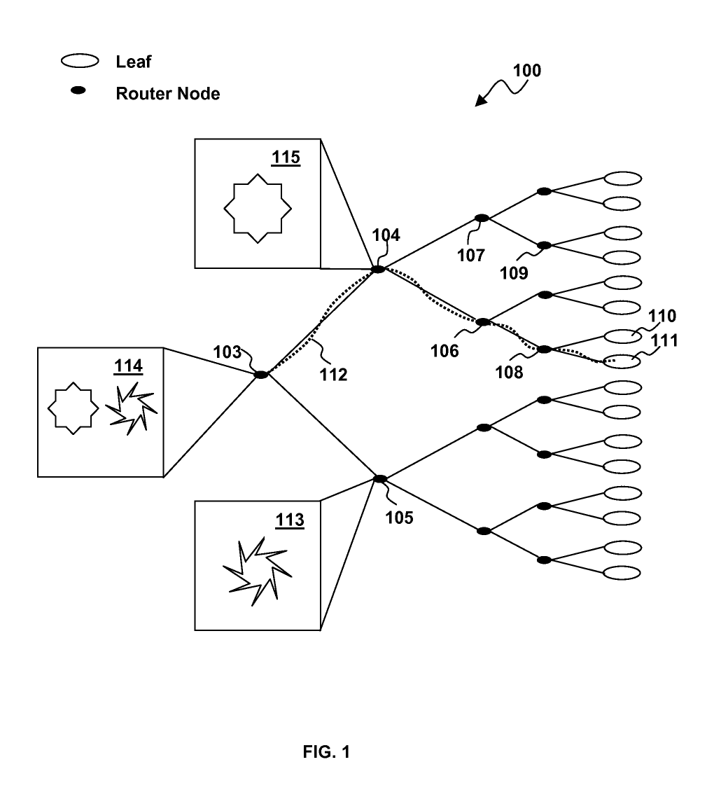

The particular values and configurations discussed in these non-limiting examples can be varied and are cited merely to illustrate an embodiment of the present invention and are not intended to limit the scope of the invention. Note that in FIGS. 1-5, identical or similar parts or elements are generally indicated by identical reference numerals.

FIG. 1 illustrates a schematic diagram of an example hierarchical router tree 100, in accordance with an embodiment. As indicated in FIG. 1, all router nodes have associated with a pictogram, such as, for example, pictogram 115 of node 104. A pictogram enables a user to identify the node. The pictograms are simply an arrangement of pixels. User traffic enters from the trunk node 103 and progresses up the tree of router nodes to the leaf nodes. At each router node, the “question” that is asked to the user is simply a presentation of the router nodes below it. For the example path 112, starting at the trunk node 103, the first “question” is a presentation of the pictograms of nodes 104 and 105. In this example, assume that the user selects node 104 and is then shown the pictograms of 107 and 106, selects 106 and is then shown the pictograms of nodes 109 and 108. Finally, the user selects 108 and is shown the pictograms of leaf nodes 110 and 111. When the user selects the leaf node 111, it becomes the “served” node 111.

The example router tree 100 illustrated in FIG. 1 is a hypothetical tree. That is, the router tree 100 is an idealized representation of one possible tree that could emerge from a process. The system can learn how to form the hierarchy simply by recording the choices of users as they click their way through initially random sets of pictograms. The routing structure that emerges may not even be a hierarchy. As the system learns the choices of pictograms, the system bias nodes in such a way as to maximize its ability to route users to what they are searching for. Taking the FIG. 1 as an example, suppose a user enters the system through router node 103. The system presents the pictograms of the router nodes children, 104 and 105. An example pictogram for router 105 is shown as 113 and an example pictogram for router node 104 is shown as 115.

Thus, the first piction asked to the user is a choice between pictograms 115 and 113, which is illustrated as a piction 114. In this example, the user chooses pictogram 115, which moves the user to router node 104, where the process is repeated. After four selections the user has navigated to the leaf node 111 along path 112. The navigation path can be through the nodes 103,104,106,108 and 111, which is simply a list of the nodes traversed in getting to the leaf node.

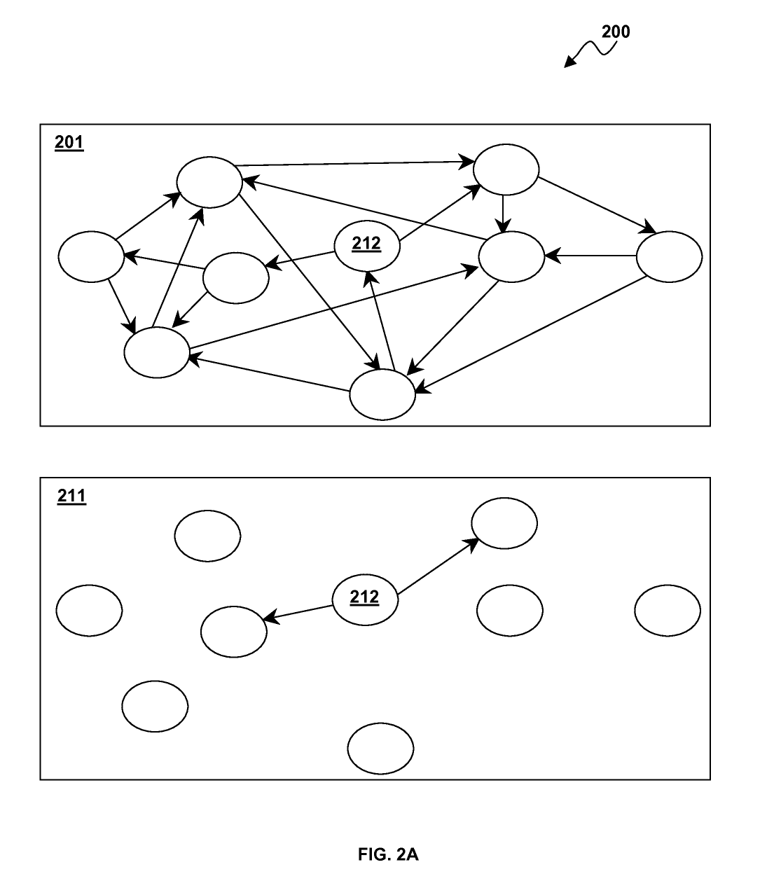

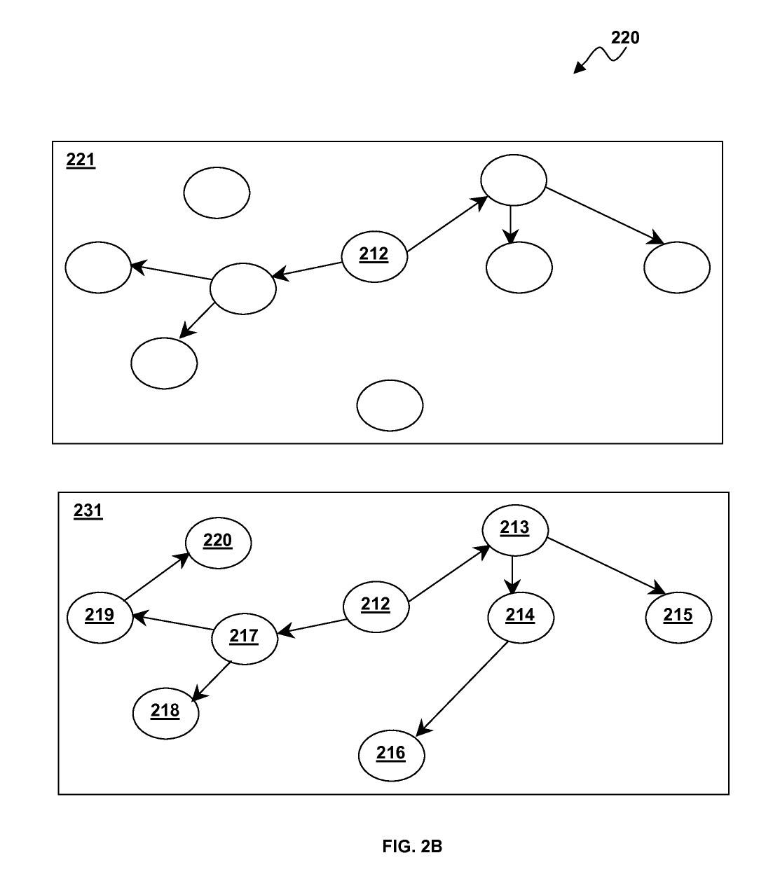

FIG. 2A illustrates a system 200 including two subgraphs 201 and 211 and FIG. 2B illustrates a system 220 including two subgraphs 221 and 231, in accordance with an embodiment. The subgraph 201 depicts nine randomly connected resources, one of which is resource 212. These resources may correspond to any entity in the known universe and each resource represents the data structure that associates this entity with a pictogram. The resource 212 is called the root resource. A search may progress outward into the network utilizing direction network connections or links. The resources directly connected to the root resource have a depth of 1, as depicted in subgraph 211. Likewise, the resources connected by two links have a depth of 2, as depicted in subgraph 221, and so on for greater number of links, shown here up to a depth of 3. When a user navigates the resources they must do it along the network structure. The structure may start out random if no other structure is available. It is highly favorable that the network structure be of the small-world type, where many local connections exist with fewer long range connections, the result being that any two resources can be connected to each other with few links. A search procedure must traverse into the network along the network links. Search priority may be biased by link weight such that resource that are connected to the root resource where strong weights are favored and further explored over resources connected with weaker weights. This can be seen in subgraph 231, where links with higher priority are shown drawn with a heavier weight line.

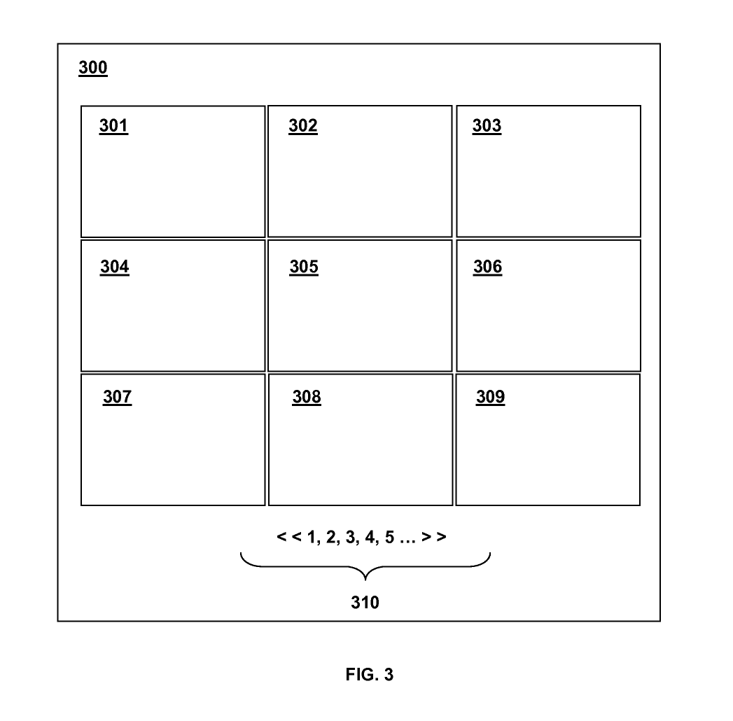

FIG. 3 illustrates a sample piction composed of a grid of pictograms. The Pictograms representative of each resource may be displayed to the user in such an array after a search over the research network has been accomplished. FIG. 3 utilizes the method of searching the network, using subgraph 231 of FIG. 2 as a reference. The search will provide all resources connected to the target resource up to a specified depth. Assume that resource 212 is the root resource, meaning that the user had previously clicked on that resources pictogram and now it is the “base” of the search. As can be seen, resource 212 is connected to resources 213 and 216 and the link between resource 212 and resource 213 is stronger; thus the search will progress along the resource 212-213 link. Once at 213, the search will progress to resource 215, as this is the stronger link. The search has encountered a “dead end”. Moving backward to resource 213, the next available link is to resource 214 and then to resource 216 where a “dead end” is reached. Backtracking to resource 212, the search progresses to resources 216, 217, 219, 220, backtracks to resource 217 and finally to resource 218. The final search result is thus through 213, 215, 214, 216, 217, 219, 220 and 218. This result may be displayed in this order as a piction, although other ordering arrangements are possible, which are discussed herein. As an example, resource piction 213 may be displayed in block 301, resource piction 215 in block 302, etc. For a large and highly interconnected network the number of search results may be very large. So long as the network structure possesses sufficient connectivity, the search tree may be terminated at a specified depth, for example 3, or until a set number of results have been found. Many results may be retrieved, and these results may be displayed on multiple pages, which may be accessed by clicking on an URL link. An example of this is given by URL links 310 that let a user navigate the multiple pages of results. If a result is not available on the first page, multiple pages may be explored.

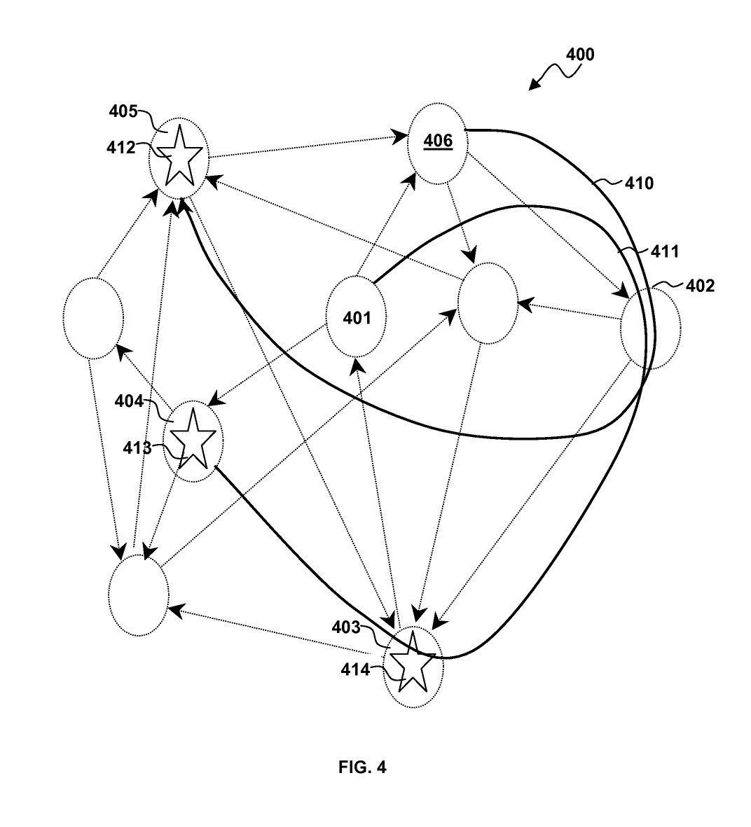

FIG. 4 illustrates how the user interaction may be incorporated into the network structure so as to improve future performance. Assume for sake of example, that two users or the same user at different times, select resources from generated pictions. The results of these selections are shown as paths 410 and 411. It can be seen that path 410 precedes through resources 406, 402 and 405; and path 411 proceeds through resources 401, 402, 403 and 404. It is important to understand that a path is a means of finding what one is looking for. Thus there is a distinction between a resource being selected for further network search and a resource being selected as the “target”. If a resource is selected as the target this means the user has found what they were looking for or otherwise have found something they are interested in. The system must thus organize itself to maximize the number of user target selections. Multiple target selections may occur on each path. As an example, a user may select a resource for target selection and this would open up a new browser window, yet still allow the user to perform network selections. Target selections are indicated in FIG. 4 as a star within each resource. Thus path 411 registered two target selections, illustrated by stars 414 and 413. The target selection of path 410 is indicated as a star 412. The system must organize itself to maximize the number of target selections, as this is indicative of a user finding what they want to find. The paths 410 and 411 ends on the resource 402. The path 410 led to one target selection and path 411 led to two target selections. Without any other information a general observation can be made that the path 411 was better than path 410 because it led to more target selection. Thus, at a time in the future when another user selects resource 402, the link to resource 414 will be searched and displayed preferentially. A method must thus be available that updates the network link weights in such a manner as to encourage paths with high rates of target selections over paths with fewer selections.

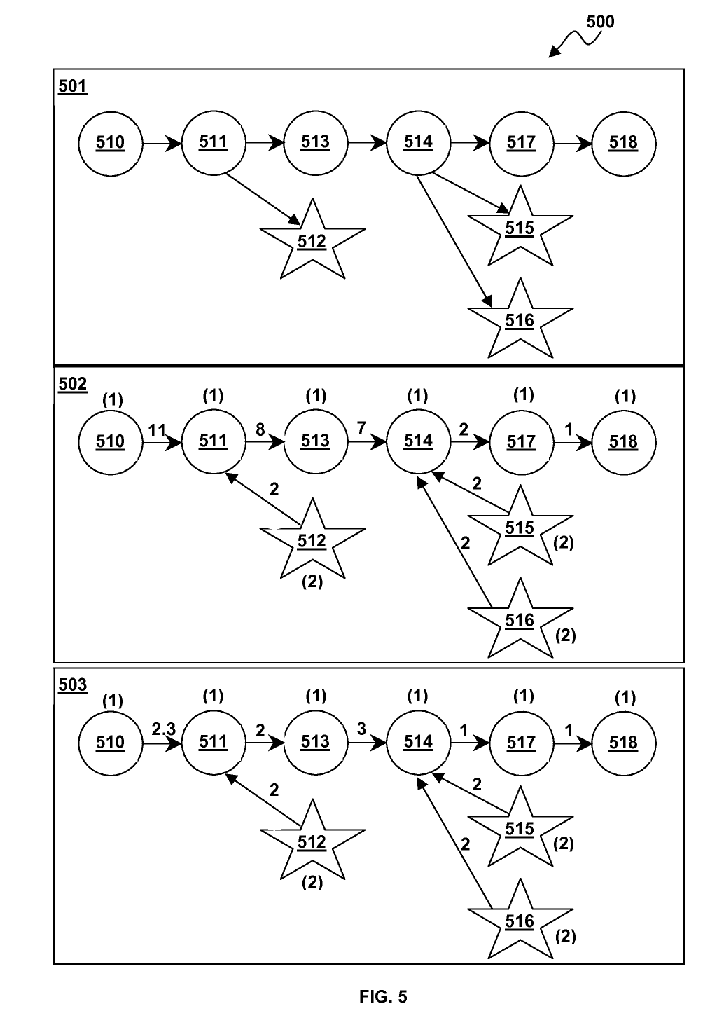

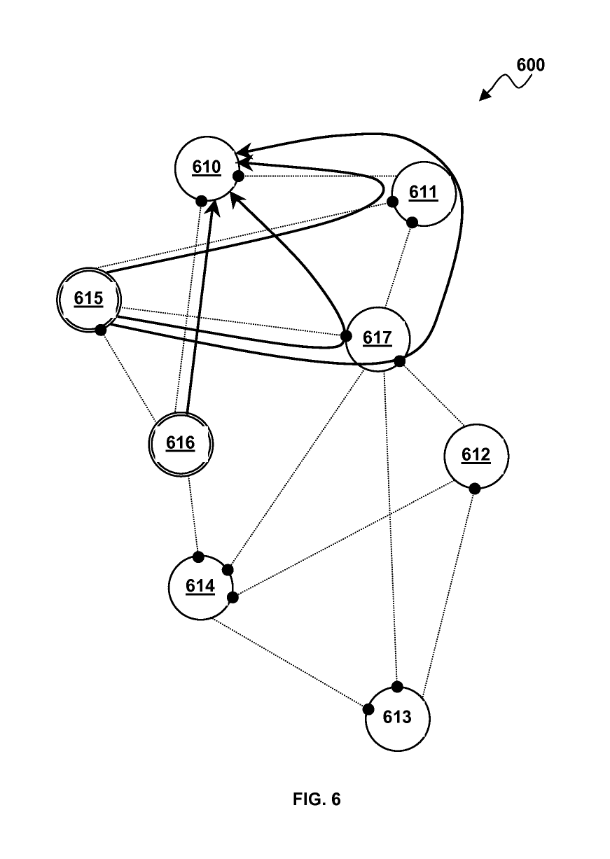

FIG. 5 shows three views of an example user path. The resources that are selected as a target are shown as stars 512, 515 and 516. The resources that are selected for network search are shown as circles 510, 511, 513, 514, 517, and 518. In this example, a user started his search by selecting resource 510 for a network search. A piction was then created by searching the network using resource 510 as the root node (not shown). Resource 511 was chosen and another network search was initiated, this time using resource 511 as the root node. From the result, resource 512 was selected as a target. Practically this could mean that a URL dedicated to resource 512 was opened in another internet browser window, although many actions are possible. In this example the user continues to search, selecting resource 513 and 514 for network search, then selecting resources 515 and 516 as targets, followed by resources 517 and 518 for network search. The user may continue in this manner to construct paths of any size.

Once a path has been constructed it contains the information that can be utilized to update the resource network link weights for refining further searches. This may be done in the following manner. First, assume that each target-selected resource is a source for a flow (current) and that network-selected resources and the links between them act as conduits for this flow, which proceeds in a direction opposite that of the link direction. Further assume that a percentage of flow is lost after passing though each resource. Using FIG. 5 as an example, resource 515, 516 and 512 become sources of a flow, which progresses in a direction “down-link” until it reached resource 510. Resources 517 and 518 did not lead to target selections, however they were the result of an intelligence system (the human user) making selections. For this reason it is advantageous to assign a small but non-negligible flow to each resource.

For the sake of this example, each network-selected resource can be defined as a source of flow of magnitude “1” and target-selection resources as a flow source of magnitude “2”. For the sake of this example it was assumed that the total flow loss at each resource is zero. The flow values passing through each link can be easily calculated which is shown in subgraph 502. The flow source values are marked in parenthesis, for example “(2)”, while flow values through links are marked without parenthesis, for example “7”. Since there is no loss of flow at each resource the total flow increases monotonically as the flow approaches the path's starting resource. This is not ideal. It is certainly not the case that the links leading away from the starting resource are the “most important” links. Although it is true that all target selections occurred by following the links projecting from the starting resource, it could easily be the case that many paths could lead to any given resource. To capture this important observation it is necessary that each resource act as a sink or “leak” for some flow. The subgraph 503 illustrates the case where each resource “leaks” 50% of the incoming flow. This insures that a long path of network-selected resources void of target selections will maintain a bounded flow value and that links to resources that occurred many steps before a target selection, do not become overly rewarded.

Once a flow path has been calculated it can be added to the network links. This is done simply by taking the flow value calculated and adding it to the existing network weights. For example, if resources 510 and 511 of subgraph 503 previously were connected by a link of weight 1, the new link weight would be 1+2.5=3.5. It may be the case that the link did not previously exist. This is due to the fact that the network search returns resources that are linked up to a specified depth, for example 3. Whereas resource “A” connects to “B” which connects to “C”, a piction may be created containing both B and C, and the user may choose C, thus establish a link directly to C bypassing B. This is a powerful mechanism whereby the network structure will evolve over time to maximize target selections by restructuring the network connections. To clear a point of potential confusion, it should be stressed that links are directional. Whereas path links project in one direction, flow values (which become the magnitude of the link weight increments) project in the opposite direction. A link weight is a static quantity. A flow value is a dynamic quantity.

It may not be desirable that the network weights always increase over time. In fact this can create a positive feedback condition that prevents the network from learning or finding new paths. For this reason it may be advantageous to decay the network weights over time. This means that each link weight is decreased by some percentage every unit time, for example 1% every day. Over time this will insure that a path that was once popular but is no longer will not bias the network search results. Stated another way, only paths that consistently work become rewarded over the long run. If a path becomes ineffective it will decay without reinforcement. Since network weights are increased linearly but decay exponentially, this insures that each link weight will reach a stable maximal value over time and not increase without bound.

The FIGS. 1-5 discusses the methods for obtaining resources from a network, using such resource to construct a piction, and using the user selections to construct path information to update the network structure so as to improve future searches. These are powerful methods that can result in vastly increased searching utility over existing systems. However, the network structure may be used in other ways to perform more powerful searches. In FIG. 4 the paths 410 and 411 intersect on the resource 402. Although it is possible that the user who created each of these paths was searching for the same thing, it could be that resource 402 represented different aspects of what each user was searching for. For example, consider two users looking for shoes. Resource 402 may be a “red sneaker”. Whereas the user that generated path 410 may have been looking for sneakers, the user that generated path 411 may have been interested in only red shoes. Thus the system should take into consideration all previous network-selected resources in the user's path. To incorporate this, dynamic biasing can be applied to the network to further order the search results.

FIG. 6 shows a network of resources. The lines with dots represent a network link weight and the dot represents the direction. Lines with arrows represent the dynamic flow. The resources with double circle represent the resources on the user's path. That is, a user has network-selected resource 615 and then resource 616. Notice that the link between resource 616 and 614 is larger than the other links. Thus, without taking into consideration the larger network structure or the users past resource selections, resource 614 is the most highly connected to resource 616 and will be ranked first in the generation of the piction. However, if one looks at the larger network structure and the previous selection (resource 615), this is not ideal. As is shown, many network paths exist from resource 615 and 616 to resource 610. Although resource 614 is connected to resource 616 with the largest weight, there are no direct or multi-step paths from the user's previous selections, and only one path from the root resource 616. Furthermore, by looking at the network structure it can be seen that resources 615, 616, 610, 611 and 617 are highly interconnected to each other and form a group, which is called as G0. Resources 617, 612, 613 and 614 are highly interconnected and form another group, G1. For the sake of example, G0 could represent all sneakers and G1 would represent all red shoes. Resources 616 and 617 are therefore red sneakers. The user's previous two selections (615 and 616) were sneakers. It is more likely that the user is looking for sneakers and not read shoes. However, if only the local network link structure around the root resource is used, the system will determine that resource 614 is the best next choice.

Assume, for example, that resource 614 was a red leather knee-high fetish boot, which is not an option one usually likes to stumble upon in the search for sneakers. To solve this problem, the past user selections may act as a source of flow that penetrates the network along its link weights and biases the search process and/or the ordering of the results. In the example of FIG. 6, the resource 615 projects to resource 617 and 611, and both of these project to resource 610. Furthermore, resource 616 directly projects to resource 610. This network structure can be to bias the search results so that resource 614 is not the dominate search result. For every resource in the user's path, a “flow tree” can be constructed as follows. It was assumed that each resource is a source of a set quantity of flow, say “1”. This flow is radiated outward into the network along the resources links, in proportion to the link weights. For example (not shown), if resource A connects to resources B and C through links of strength 1 and 2, respectively, then ⅓ of the flow will project to resource B and ⅔ to resource C. For each of these resources, the flow is divided and projected to their links, up to a pre-specified network depth. If this is done for all resources in the path, each resource will now have a dynamic quantity, “the flow” that can be used to order the search results or bias the search. The resources with the most flow will be counted as more relevant then resources with less flow. In such a way the total network structure and the many possible paths to a resource may be taken into consideration to determine more precisely what a user is looking for or otherwise will like. Thus a search may proceed by first projecting a flow into the network, then performing a network search, and finally by ordering the search results by flow. It can be appreciated that the term “flow” in this context could be replaced with “activation” or “activation flow” to achieve similar results.

The system in the context of performing a search is based on the users “likes”. Equally as important are the users “dislikes”. Whereas a resource may be selected as a target, a resource may also be selected as an “anti-target”. That is, the user may select a piction that does not represent what they are looking for, or otherwise they simply do not like it. Taking this information into account is a simple extension of the methods described above. Whereas the resources on the user's path represent their likes, we may just as easily allow for feedback such that the user may label a resource as a dislike. In this case the search can bias the results as above by accounting for dislikes with negative flow. That is, rather than projecting a “positive” flow into the network, a negative flow is projected into the network. The sum total of both positive and negative flow thus determines the search result ordering.

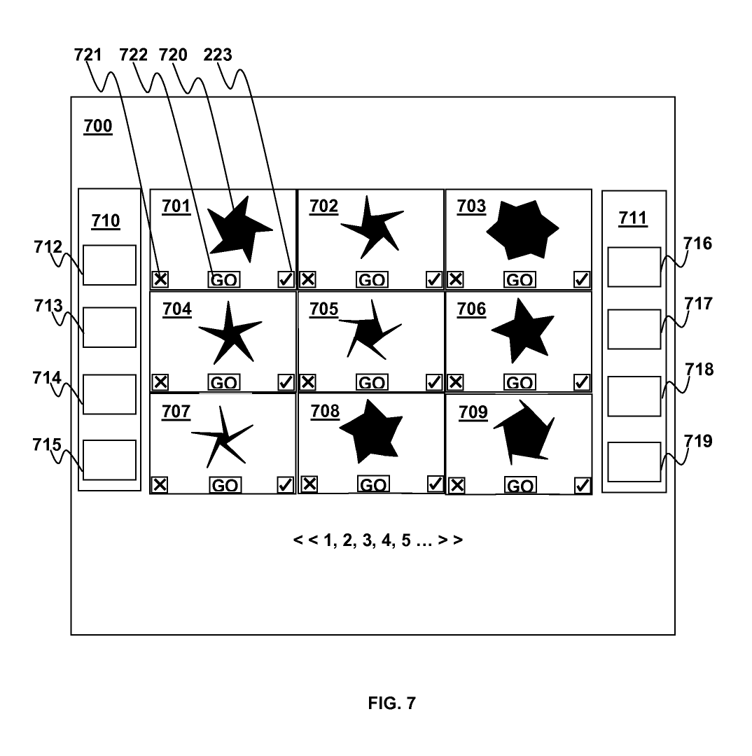

The ultimate goal for a search engine is provide search results that are relevant to the user. As mentioned, this becomes very difficult for situations where the user does not know what words to use to perform a search, or even when the user is not sure what they are searching for. An interface is thus needed that lets a user narrow in on what they like. Based on the above methods it is easy to understand how a user's selection of resources that they like and do not like can be used to bias a network search. FIG. 7 shows one possible graphical user interface. An array of pictograms is displayed, shown here as blocks 701 through 709. Associated with each pictogram block are buttons 721, 722 and 723. The user presses the button 721 to indicate that he or she like the resource. The user presses the button 722 or 723 to indicate that he or she like or do not like the resource respectively and the button 722 takes the user to a dedicated URL for that resource. When button 721 is pressed for a resource, the pictogram or some other representation of the resource is moved to the “dislikes” area, here marked as 710. Likewise, button 723 places a pictogram or some other representation into the “likes” area, here represented as area 711. The “dislike” area 710 comprises areas 712, 713, 714 and 715 and the “like” area 711 comprises areas 716, 717, 718 and 719. Once the user has made selections that state their preferences, the system may perform a network search using the methods stated above to bias the network through flow.

A useful feature of this biasing is that it lets some resources act as sources of higher flow. The result is that the user may order their likes or dislikes so that the system biases some likes and some dislikes more than others. As an example, resource pictogram 716 is above 717, which is above 718, etc. This implies an ordering so that, during the network search resource 716 acts as a source of flow that is higher than resource 717, which in turn is higher than resource 718, etc.

As previously discussed, each resource is associated with a pictogram. Such a pictogram may be virtually anything, including pictures, text, color fields or most generically just an array of pixels values. Here lies a potential problem. It may be the case that a pictogram as originally created is not very representative of a resource or is otherwise not as representative as it could be. Perhaps the pictogram failed to account for some aspect or property of the resource. What is needed is a way to update, change or otherwise modify the pictograms over time in a way that improves the systems performance. This can be achieved through an “evolution” of the pictograms as follows. For each resource associated two or more pictograms, each with a slight (and unique) variation. Every time a piction is created that includes the resource, a pictogram to be displayed is chosen at random through a probability function. The ratio of the number of times the pictogram was displayed versus the number of times it was clicked is measured. This ratio is called as click-through rate. The probability function that is to include this information is updates. For example, pictograms with a higher click-through rate should be biased to be displayed over those with low click-through rates. The inferior pictograms are mutated and repeated. Over time this process may act to evolve the pictograms in a direction that maximizes their click-through rate.

The primary motive of a search engine is to provide users with what they are looking for. Some results are better than others, and it is advantageous for the system to obtain feedback. In the learning process, target-selected resources may turn out to be uninteresting to the user. In such a case the user will return immediately to the search engine and continue their search. Thus the time interval between the users target selection and the next network selection can be used as a basic measure of users' interest in the resource. Short times correspond to low interest and large times to high interest. For this method to work it is important that the user eventually return to their search so that a time may be measured, otherwise it may be the case that the search was abandoned.

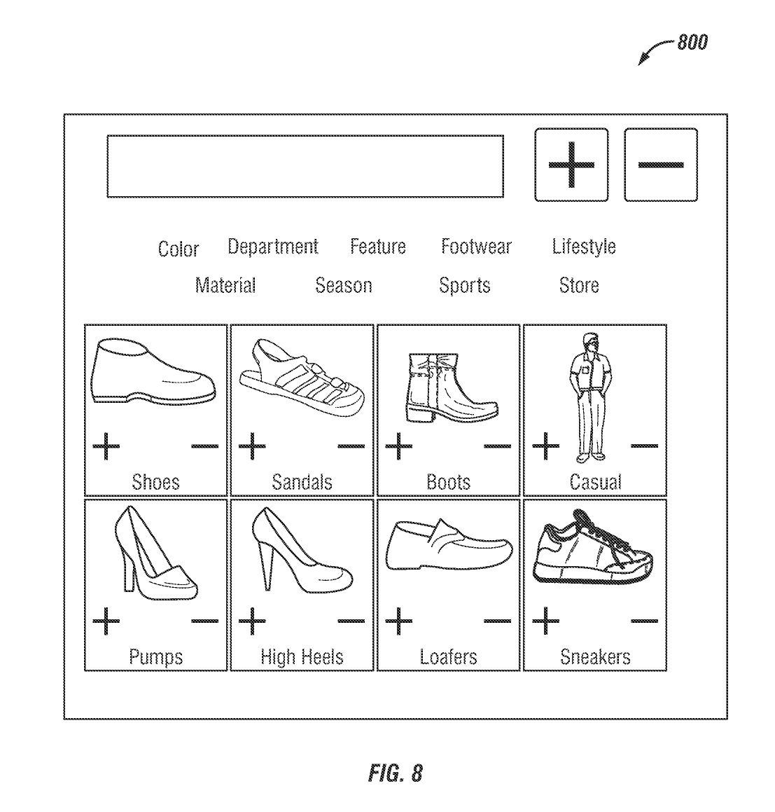

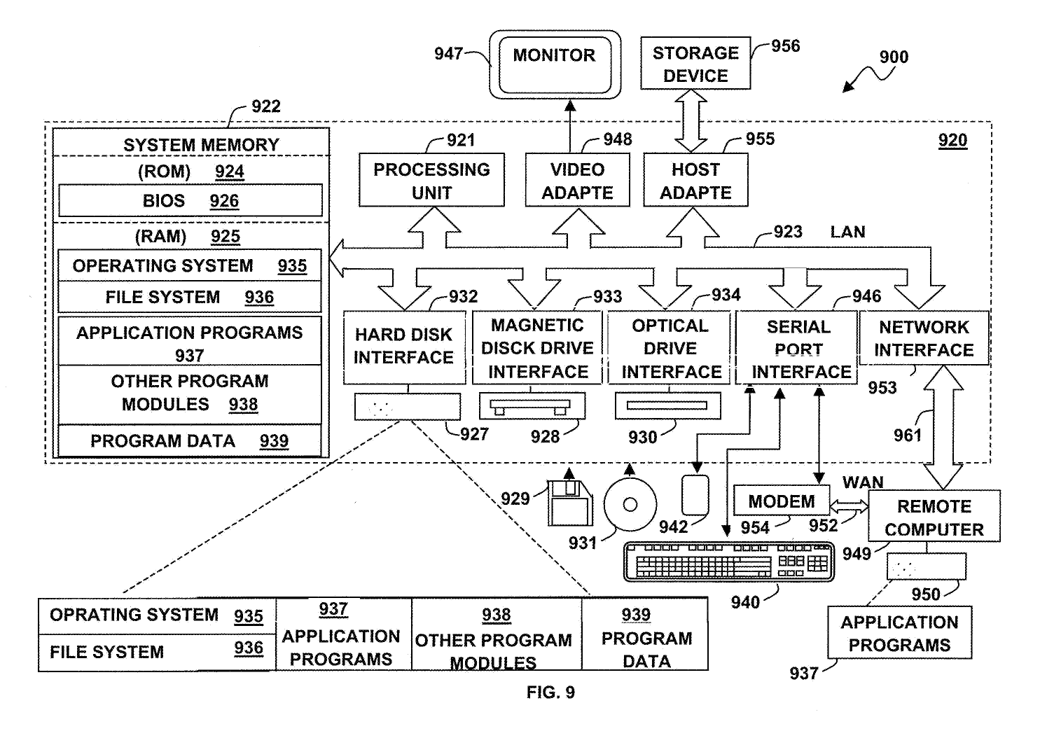

A variety of user interfaces may be utilized to answer pictions (to select a pictogram from a set of pictograms). The piction may be displayed in the context of a GUI (Graphical User Interface). Note that a GUI as utilized herein refers generally to a type of user interface that allows users to interact with electronic devices, such as, for example, computers, hand-held devices such as MP3 Players, Portable Media Players or Gaming devices, household appliances and office equipment with images rather than text commands. A GUI offers graphical icons and visual indicators, as opposed to text-based interfaces, typed command labels or text navigation to fully represent the information and actions available to a user. The actions are usually performed through direct manipulation of the graphical elements. FIG. 8 illustrates an example of a GUI 800, which may be utilized in accordance with the disclosed embodiments. The GUI 800 represents just one example of a GUI that may be utilized in accordance with the disclosed embodiments. Other types of GUI's may also be utilized through a computer monitor such as, for example, monitor 947 depicted in FIG. 9. Such a selection may be through a pointing device such as the mouse 942 depicted in FIG. 9, or another pointing device, depending upon design considerations. For, example, in some applications, monitor 947 may be implemented as a touch screen display device. The piction could be displayed on such a touch monitor and the selection made by simply touching the screen. The piction could be displayed on a monitor and the selection could be made through a camera tracking the eye movements of the user, or image recognition systems detecting a pointing action, or a voice recognition system detecting an identification number displayed alongside the pictogram.

The very basic mechanism for search is user selection. This selection can be made in a number of ways. A potentially powerful method is through gaze detection. A piction with a small number of pictographs is displayed and a gaze-tracking system makes the determination as to what pictogram the user is looking at. This causes a network selection, which changes the images. This called a Gaze-Tracking Interface. This provides a powerful interface for two situations. First, it may be used in the window of merchant stores to display images of products in the store. Users walking by can partake in a selection-based network search of the products in the store simply by looking at the images. If the merchant has a product that the user is interested in it will likely be shown to the user, at which point the user may enter the store or come back at a later time if the store is not open. The merchant also gets valuable information as to the likes of the users who walk by the store. Products that receive high selections may be placed in the merchant stores window, or otherwise more prominently advertised.

Generically, the system may provide a report to the merchant as to the number of user selections each product received, and this information is valuable to the merchant in optimizing their store front. Second, such a system may be used for market brand evolution. The search mechanism can be used through a gaze-tracking system to evolve product brands, where each brand is a pictogram with a slight variation. The selection rate can then be used to copy and mutate the highly selected pictograms. This provides valuable information to marketing companies to optimize product brands.

With reference to FIG. 9, an exemplary computer system 900 is depicted, wherein an embodiment may be implemented. The system 900 generally includes a general purpose computing device in the form of a user-side computer and/or server-side computer 920 or the like, including a processing unit 921, a system memory 922, and a system bus 923 that couples various system components including the system memory to the processing unit 921. The system bus 923 may be any of several types of bus structures including a memory bus or memory controller, a peripheral bus, and a local bus using any of a variety of bus architectures.

The system memory includes read-only memory (ROM) 924 and random access memory (RAM) 925. A basic input/output system 926 (BIOS), containing the basic routines that help to transfer information between elements within the computer 920, such as during start-up, is stored in ROM 24. The computer 920 may further include a hard disk drive 927 for reading from and writing to a hard disk, not shown, a magnetic disk drive 928 for reading from or writing to a removable magnetic disk 929, and an optical disk drive 930 for reading from or writing to a removable optical disk 931 such as a CD-ROM, DVD-ROM or other optical media.

The hard disk drive 927, magnetic disk drive 928, and optical disk drive 930 are connected to the system bus 923 by a hard disk drive interface 932, a magnetic disk drive interface 933, and an optical drive interface 934, respectively. The drives and their associated computer-readable media provide non-volatile storage of computer readable instructions, data structures, program modules and other data for the computer 920. Although the exemplary environment described herein employs a hard disk, a removable magnetic disk 929 and a removable optical disk 931, it should be appreciated by those skilled in the art that other types of computer readable media that can store data that is accessible by a computer, such as magnetic cassettes, flash memory cards, digital video disks, Bernoulli cartridges, random access memories (RAMs), read-only memories (ROMs) and the like may also be used in the exemplary operating environment.

A number of program modules may be stored on the hard disk, magnetic disk 929, optical disk 931, ROM 924 or RAM 925, including an operating system 935 (e.g., DOS, Windows, Linux, Unix, etc). The computer 920 includes a file system 936 associated with or included within the operating system 935, New Technology File System (NTFS), one or more application programs 937, other program modules 938 and program data 939. A user may enter commands and information into the computer 920 through input devices such as a keyboard 940 and pointing device 942. Other input devices (not shown) may include a microphone, joystick, game pad, satellite dish, scanner or the like.

These and other input devices are often connected to the processing unit 921 through a serial port interface 946 that is coupled to the system bus, but may be connected by other interfaces, such as a parallel port, game port or universal serial bus (USB). A monitor 947 or other type of display device is also connected to the system bus 923 through an interface, such as a video adapter 948. In addition to the monitor 947, computers typically include other peripheral output devices (not shown), such as speakers and printers.

It can be appreciated that the methodology discussed herein can be implemented in the context one or more program modules 938 and/or application programs 937 and/or in association with program data 939, depending upon design considerations. Application program(s) 937 may be, for example, a program designed to perform a specific function directly for the user or, in some cases, for another application program. Examples of application programs includes word processors, database programs, web browsers, development tools, drawing, paint, and image editing programs and communication programs. Application programs use the services of the operating system 935 and other supporting programs. The formal requests for services and means of communicating with other programs that a programmer uses in writing an application program is called the application program interface (API).

When used in a LAN networking environment, the computer 920 may be connected to the local network 951 through a network interface or adapter 953, which may provide for wireless and/or wired connections to various types of networks. For example, the local network 951 may be a wireless network or may provide wireless connections to other networks and services. The network interface 953 may include connections, such as wire, wireless communication links, or fiber optic cables.

When used in a WAN networking environment, the computer 920 may include the use of a modem 954 or other means for establishing communications over the wide area network 952, such as the Internet. The modem 954, which may be internal or external, can be connected to the system bus 923 through the serial port interface 946. The modem 952 can be connected to the remote computer 949 which includes a hard disk drive 950. In a networked environment, program modules depicted relative to the computer 920, or portions thereof, may be stored in the remote memory storage device. It will be appreciated that the network connections shown are exemplary and other means of establishing a communications link between the computers may be used.

Note that in some embodiments, the various logical operational steps of the methods disclosed herein may be implemented as instructions in the context of a computer-useable medium such as system 900 that contains a program product. Programs defining functions on the present invention can be delivered to a data storage system or a computer system such as system 900 through a variety of signal-bearing media, which include, without limitation, non-writable storage media (e.g., CD-ROM), writable storage media (e.g., hard disk drive, read/write CD ROM, optical media), system memory such as, but not limited to Random Access Memory (RAM), and communication media, such as computer and telephone networks including Ethernet, the Internet, wireless networks, and like network systems. It should be understood, therefore, that such signal-bearing media when carrying or encoding computer readable instructions of the methods disclosed herein, may represent alternative embodiments of the present invention. Further, it is understood that the present invention may be implemented by a system such as, for example system 900, having components or modules in the form of hardware, software, or a combination of software and hardware as described herein or their equivalent. Thus, the methods described herein can be deployed as process software in the context of a computer system or data-processing apparatus and/or system as that depicted in FIG. 9.

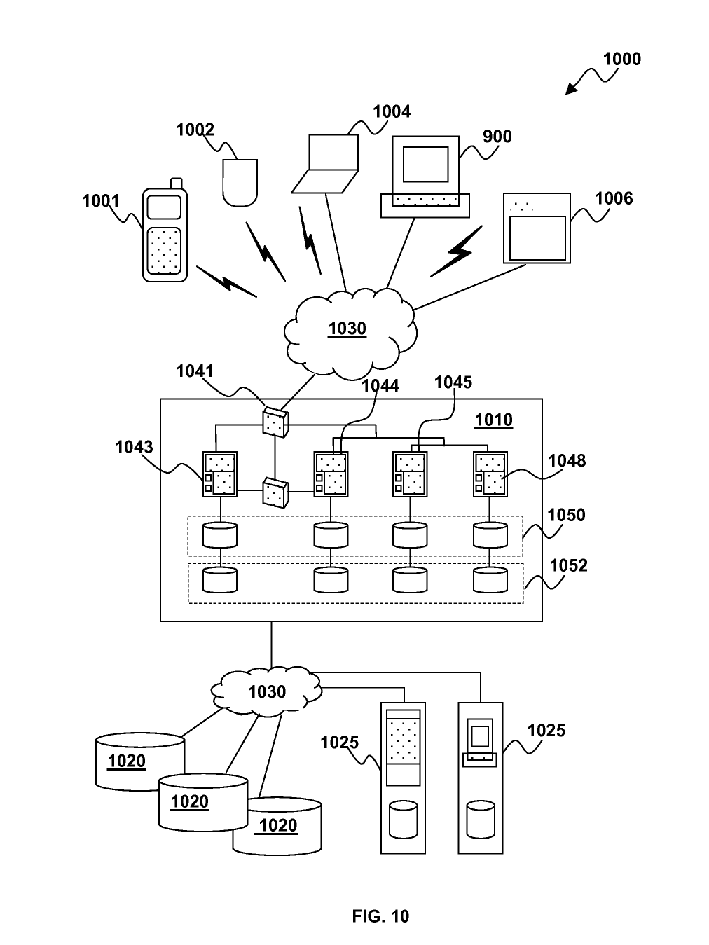

FIG. 10 illustrates a block diagram of an exemplary communications system 1000, which may be utilized to implement an embodiment. The communications system 1000 generally includes one or more user devices such as, for example, devices 1001, 1002, 1004, 900, 1006, and so forth. The system 1000 further includes a service provider system 1010, other Internet Service Providers (ISP) and websites 1020, system partners 1025, and various communication paths 1030. As the communication system 1000 is device and source agnostic, it can be designed to work with any web-accessible user device, as explained in further detail below.

The user devices 1001, 1002, 1004, 900 and 1006 may be any type of electronic device that presents content received from the service provider system to the user. For example, the user device 1001 may be a mobile telephone or smartphone, and user device 1002 may be a wireless PDA (Personal Digital Assistant) 1002 that also function as a mobile telephone. User device 1004 may be, for example, a hand held/mobile or laptop/notebook computer, and user device 900 may be, for example, a personal computer a work station, a vehicle computer, a game system, a set-top-box, or any other device that can implement a user interface and/or browser to communicate with and present content from the service provider system 110. Similarly, user device 1006 may be a gaming console, a tablet computer and so forth.

Such user devices may include a processing device, one or more storage devices, and one or more communications interfaces. Such user devices also may include additional elements, such as, for example, one or more displays or screens, one or more speakers, one or more user input devices, and a microphone. Such user devices also may include one or more associated peripheral devices, such as, for example, a display, a memory, a printer, an input device, an output device, and speakers.

The processing device may be implemented using any general-purpose or special purpose computer, such as, for example, a processor, a digital signal processor, a microcomputer, a field programmable array, a programmable logic unit, a microprocessor or any other device capable of responding to and executing instructions in a defined manner. The processing device may run one or more software applications that communicate with the service provider system 1010 and present content received from the server provider system 1010 to the user. The processing device also may access, store, manipulate, process, and create data in response to the applications. The software applications may include a computer program, a piece of code, an instruction, or some combination thereof, for independently or collectively instructing the processing device to operate as desired. Examples of software applications include: a browser, a mini browser, or other programs that interact with a front end interface application (FEIA) provided by the service provider system 1010 to provide content, a login/signup, a user interface, and email among other features. Other examples of applications, include a mobile front end interface applications (e.g., for a cell or a smart phone) that allow the user device to communicate with the system service provider 1010.

The applications, content, and data may be embodied permanently or temporarily in any type of machine, component, physical or virtual equipment, storage medium or device, or propagated signal wave capable of providing instructions or data to or being interpreted by the processing device. In particular, the applications or data may be stored by a storage medium or a memory including volatile and non-volatile memories that store digital data (e.g., a read only memory (ROM), a random access memory (RAM), a flash memory, a floppy disk, a hard disk, a compact disk, a tape, a DROM, a flip-flop, a register, a buffer, an SRAM, DRAM, PROM, EPROM, OPTROM, EEPROM, NOVRAM, or RAMBUS), such that if the memory is read or accessed by the processing device, the specified steps, processes, and/or instructions are performed and/or data is accessed, processed, or stored. The memory may include an I/O interface, such that data and applications may be loaded and stored in the memory allowing the applications, programming, and data to be updated, deleted, changed, or augmented. The memory may be removable, such as, for example, a card, a stick, or a disk that is inserted in or removed from the unit.

The communications interface may exchange data and content with the service provider system 1010 using various communications paths 1030. The interface allows the processing device to send and receive information using the communications paths 1030. The communications interface may be implemented as part of the processing device or separately to allow the processing device to communicate using the communications paths 1030. The interface may include two or more types of interfaces, including interfaces for different types of hardware and/or software to interact with different types of communications media and protocols and to translate information/data into a format that may be used by the processing device. Similarly, the interface may translate information/data received from the processing device to a format that may be transmitted to the service provider system 1010 through a communications path 1030.

The communications paths 1030 may be configured to send and receive signals (e.g., electrical, electromagnetic, or optical) that convey or carry data streams representing various types of analog and/or digital data including content for presentation to a user. For example, the communications paths 1030 may be implemented using various communications media and one or more networks comprising one or more network devices (e.g., network interface cards, servers, routers, switches, hubs, bridges, repeaters, blades, processors, and storage devices). The one or more networks may include a local area network (LAN), a wide area network (WAN), a global area network (GAN), a plain old telephone service (POTS) network, a digital subscriber line (DSL) network, an integrated services digital network (ISDN), a synchronous optical network (SONNET), Passive and Active Optical Networks (PON or AON), or a combination of two or more of these networks. In addition, the communications paths 1030 may include one or more wireless links (e.g., microwave, radio, and satellite) that transmit and receive electromagnetic signals, such as, for example, radio frequency, infrared, and microwave signals, to convey information/data signal. In one example, a communications path 1030 may include the Internet or World Wide Web.

The service provider system 1010 facilitates communication by, organization of, and presentation of content to users. The service provider system 1010 also stores and manages user associated information in a centralized location. In particular, the service provider system 110 implements a user interface to aggregate, consolidate, organize, and simplify a user's daily communications, such as email and instant messaging into a central point for one-stop organization, data, and content management.

The service provider system 1010 includes one or more communications devices, processors, memories/storage devices, communications interfaces, network devices, and communications paths to store, process, manipulate, organize, consolidate, maintain, and present content and data for a user. In the example shown in FIG. 10, the service provider system 1010 may include a one or more security devices 1041 (e.g., firewalls), web servers 1043, an application server 1044, an SQL server 1045 and a mirror SQL server 1048, and associated memory 1050 and backup memory devices 1052. It is understood, however, that the example depicted in FIG. 10 is for illustrative purposes only, and that different configurations, combinations of devices, and numbers of devices may be provided for any particular service provider system 1010. For example, the system service provider may include multiple banks of servers as need to supply adequate bandwidth for the number of users supported by the system. In addition, the system 1010 may be geographically distributed.

In one example, the web server 1043 may be implemented using a Quad-Core Tower Server with a Red Hat Enterprise Linux 5 operating system using an apache HTTP server programming language to provide JavaServer Pages (JSP). The web server 1043 may run a FEIA to aid in login, signup, and creation of a user account, and receive information from the first time wizard. The application server 1044 may be implemented using a Quad-Core Tower Server with a Red Hat Enterprise Linux 5 operating system using programming languages such as, for example, Java, Eclipse C/C++ IDE. The application server 1044 The application server may run system applications, such as, for example, the contact importer, harvester, and maintainer, calendar maintainer and syncer, mail fetcher/sender, threader, glad logic, glad placement applications, route mapper, item finder, client communicator, and user interface. The SQL Server 1045 may be implemented using a Quad-Core Tower Server with a Red Hat Enterprise Linux 5 operating system using, for example, an Oracle Database 11g Enterprise Edition for Linux (or equivalent) to maintain various databases, such as, for example, a contact database (DB). The mirror SQL 1048 server mirrors the SQL Server 1045 to maintain a user DB and a glad, advertisement, or customer incentive database, a store DB, a item DB, a contact DB, a message DB, among other described herein. The user database may include a user profile, user events, shopping lists, to-do lists, user groups and contact DB, and user locations DB. The term database DB includes not only the data but may include the programming of the database application for maintaining the data.

In order to interact with the service provider system 1010, a user needs to establish an account. The user must activate the account from a user device, such as, for example, 1001, 1002, 1004, 900, 1006, etc., running an application that allows the user device to communicate with the service provider system 1010, such as a browser. A browser may include any application that communicates with a web server primarily using hypertext transfer protocols HTTP (e.g., HTTP/1.1) to fetch content or provide a portal to service provided by the service provider system 1010. HTTP allows the browser to submit information to servers in addition to fetching content from them. Content may be located by the browser using a uniform resource locator (URL) as an address. Many browsers also support a variety of other URL types and their corresponding protocols, such as Gopher (a hierarchical hyperlinking protocol), file transfer protocol (FTP), real-time streaming protocol (RTSP), and an SSL encrypted version of HTTP (HTTPS). Content may be provided in a hyper-text markup language (HTML) that is identified using a MIME content type. Most browsers natively support a variety of formats in addition to HTML, such as the JPEG, PNG, and GIF image formats, and can be extended to support more through the use of plug-ins and/or scripts. The combination of HTTP content type and URL protocol specification allows images, animations, video, sound, and streaming media to be embedded in the content.

The browser may include coding that interacts with the FEIA. The initial code that is run in the browser may be downloaded from the service provider system 1010 (e.g., with purchase of an account) or retrieved from a storage medium (e.g., a CD promotional gift). The browser running on the client device 1001 connects with the FEIA application run by the service provider system 1010 web server 1043 to initiate login, account activation, and provide a first-time questionnaire. During the initial account setup, the user may create a password and/or user identification (ID). In addition, the service provider system 1010 may configure settings and data on the user device 1001 (e.g., set cookies). The service provider system 1010 also provides the user with a user profile questionnaire.

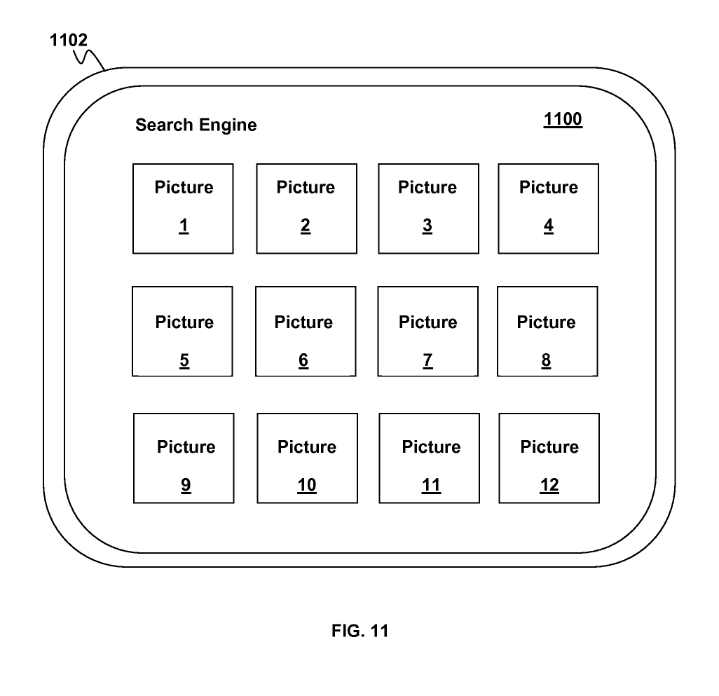

FIG. 11 illustrates a graphically displayed search engine 1100 which a user may access to search based on graphically displayed images. The search engine 1100 may displayed through a display device 1102, which is analogous, for example, to the monitor 947 depicted in FIG. 9 and/or displays associated with user devices such as, for example, devices 1001, 1002, 1004, 1006, etc. shown in FIG. 10. In the illustration depicted in FIG. 11, it can be assumed that the search engine is displayed with an application such as a browser as discussed earlier herein. A user may thus select any one of the graphically displayed images 1 to 12, which represent pictorial questions or pictions as discussed herein, to initiate a search as discussed herein with respect to FIGS. 1-8. It can be appreciated that although twelve images or pictions are illustrated in FIG. 11, fewer or more pictions may be graphically displayed through the search engine 1100, depending upon design considerations. The search engine 1100 illustrated herein thus represents the searching capabilities depicted and described herein with respect to FIGS. 1-8.

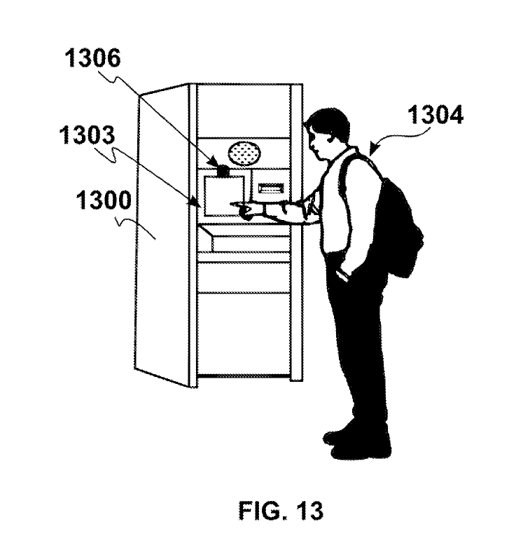

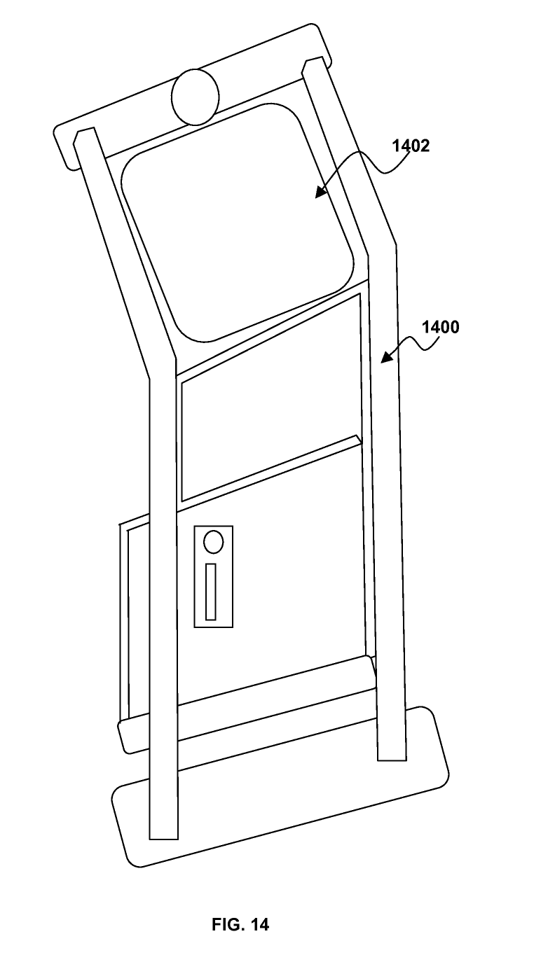

The search engine 1100 may be implemented in a number of embodiments. For example, the search engine 1100 may be offered online through the World Wide Web from a website that a users accesses to initiate a search. Another embodiment may involve the use of an electronic kiosk such as those shown in FIGS. 13-14 to implement the search engine 1100. A further embodiment involves the implementation of search engine 1100 in the context of an Internet Portal. For example, assume such an Internet Portal allows a user to search for and ultimately purchase online items such as shoes, handbags, cars, etc. One example of such an implementation is an online auction and/or shopping website in which people and business buy and sell a broad variety of goods and services worldwide. A majority of the sales in such an example may take place through a set-time auction format, but subsequent methods may include a substantial segment of listings in a “Buy It Now” category, all of which can be searched using the search engine 1100 and methodology disclosed herein.

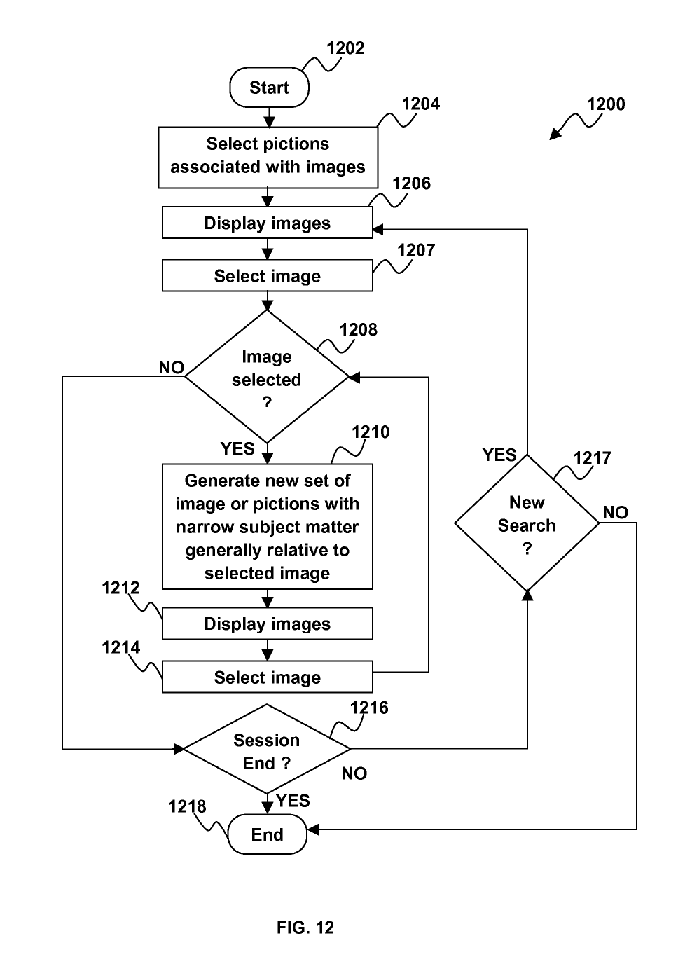

FIG. 12 illustrates a flow chart of operations depicting logical operational steps of a search engine method 1200, in accordance with an embodiment. As indicated at block 1202, the process begins. Next, as illustrated at block 1204, pictions as discussed herein are associated with images, typically based on subject matter. Examples of such pictions are images 1-12 depicted in FIG. 11. Thus, for example, a general image of food, when selected, would result in the display of a group of images more specifically related to food or various types of food and so forth. Next, as indicated at block 1206, a group of images are displayed, in response to a selection of the original image (i.e., block 1204). As illustrated thereafter, at block 1207, an image is selected and next, as depicted at block 1208, a test is performed to determine if a particular image is selected form the group of displayed images. If so, then as indicated at block 1210, a new set of images (pictions) with narrower subject matter granularity is generated relative to the selected image.

A user now has a new group of images from which to select. These new images are then displayed, as indicated at block 1212, and thereafter as depicted at block 1214, a new image is selected. The process then repeats itself with increasing granularity as indicate at block 1208, and so forth. The operation depicted at block 1217 prompts a user to initiate a new search, while the operation depicted at block 1216 determines whether or not a current search session is terminated. The entire process can end, as illustrated at block 1218.

FIGS. 13-14 illustrate examples of interactive electronic kiosks 1300 and 1400 in which an embodiment may be implemented. It can be appreciated that the disclosed search engine (e.g., can be utilized in a number of contexts, such as for, example, web-based applications. That is, a user may access a website containing the search engine to utilize and interact with such a search engine. Another application of the disclosed search engine involves electronic kiosks. Note that the computer or computing system 900 discussed earlier herein can be modified or configured for use with or an electronics kiosks 1300, 1400 depending upon design considerations.

In general, the kiosks 1300, 1400 may be configured in a sturdy, tamperproof cabinet with respective touch screen displays, such as, for example displays 1302 and 1402 and may be networked through with the Internet and/or other types of networks. The kiosks 1300, 1400 can be located in stores, shopping malls, public areas, tourist locations, and so forth. The example depicted in FIG. 13 depicts a user 1304 accessing the search engine disclosed herein through touch screen display 1302. Kiosks 1300 and 1400 each may include, for example, a bill reader, a card reader, a barcode scanner, a check scanner, a telephone handset and a receipt printer. A bill reader, for example, may accept, verify and register currency. A card reader may read a magnetic strip or, in the case of a smart card, communicates with the chip onboard the card. A barcode scanner may also be employed to read a printed barcode, such as a barcode included on a payment stub of a bill. A check scanner reads and parses account number information to assist the user in correctly identifying their checking account. A telephone handset (not shown) may be associated with the kiosks to support, for example, the making of voice over IP telephone calls, both to kiosk customer service and to friends or relatives. A receipt printer may generate user instructions or a record of a transaction. One example of such a kiosk is disclosed in U.S. Patent Publication No. 20070250384, entitled “Multi-purpose Electronic Kiosk,” by Geller, et al., and published on Oct. 25, 2007. U.S. Patent Publication No. 20070250384 is incorporated herein by reference in its entirety.

Note that in the example depicted in FIG. 13, the touch screen display device 1302 may operate in association with an eye recognition device 1308 that monitors the eye position of the user 1304 with respect to the display 1302. Thus, the eye position of the user 1304 is utilized as feedback for preference tracking. The device 1308 can thus be utilized to estimate the user gaze with respect to particular images, and hence pictions, such as the images 1-12 depicted in FIG. 11. There are a number of different types of eye recognition devices that may be utilized to implement device 1308. One example of such an eye recognition device is disclosed in U.S. Pat. No. 7,298,874, entitled “Iris Image Data Processing for Use with Iris Recognition System,” which issued to Seong-Won Cho on Nov. 20, 2007 and is incorporated herein by reference. Another example of an eye recognition device that may be utilized to implement device 1308 is disclosed in U.S. Pat. No. 7,231,069, entitled “Multiple View Angles Camera, Automatic Photographing Apparatus, and Iris Recognition Method,” which issued to Kenji Nahata on Jun. 12, 2007 and is incorporated herein by reference. A further example of an eye recognition device that may be utilized to implement device 1308 is disclosed in U.S. Patent Publication No. 20080199054, entitled “Iris Recognition for a Secure Facility” to inventor James R. Matey and which published on Aug. 21, 2008. U.S. Patent Publication No. 20080199054 is also incorporated herein by reference.

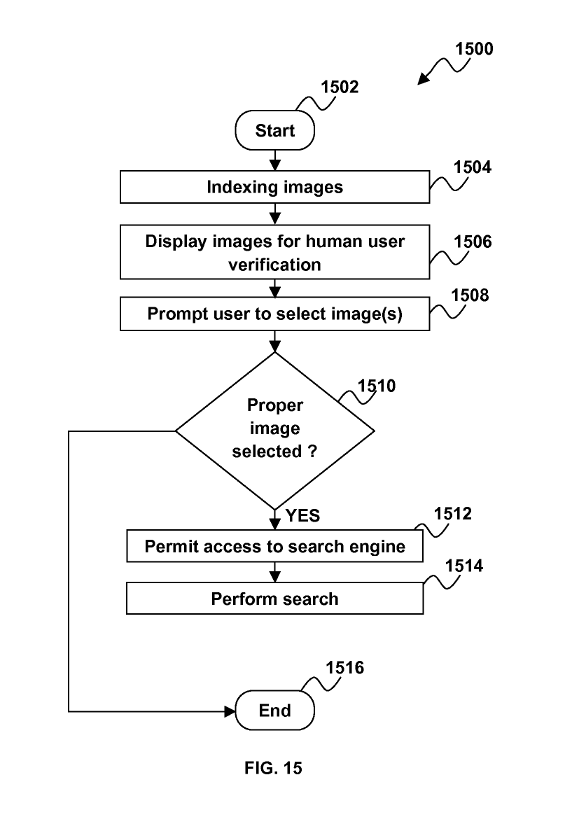

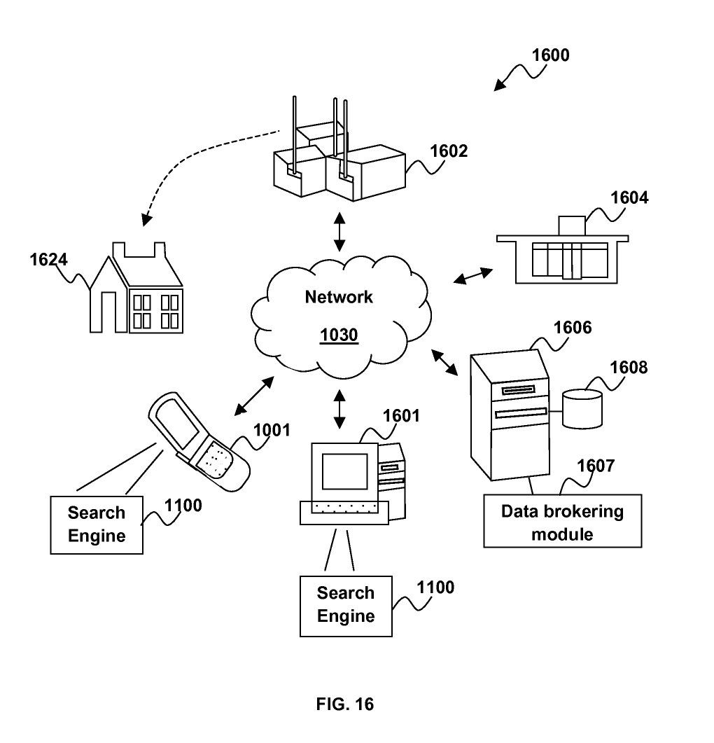

FIG. 15 illustrates a flow chart of operations depicting logical operations of a method 1500 authorizing access to the search engine 1100, in accordance with an embodiment. The method 1500 depicted in FIG. 15 can be implemented in association with the method 1200 of FIG. 12 described herein. That is, for example, the authorization steps illustrated in FIG. 15 may be processed prior to processing of the operations depicted in FIG. 11 in order to ensure that the prospective user of the search engine 1100. As indicated at block 1502 in FIG. 15, the process begins. Next, as indicated at block 1504, an operation involving the indexing images is processed. Thereafter, as indicated at block 1506, particular images are displayed for human user verification. Next, as depicted at block 1508, the user is prompted to select a particular image. Then, as illustrated at block 1510, a test is performed to determine if the proper images have been selected. If the proper images have been selected, then as indicated at block 1512, the user (e.g., user 1304) is permitted access to the search engine 1100. Thereafter, as indicated at block 1514, the operations of method 1200 of FIG. 12 can be processed. The operations illustrated in FIG. 15 can terminate, as indicated at block 1516. The method 1500 thus permits image indexing, wherein users of the search engine 1100 need to prove that they are human. This can be accomplished by correctly classifying/indexing images. Once it is known that the prospective user is human, the search engine may label the image(s) based on what is in the image(s), which can then be searched.

FIG. 16 illustrates a schematic diagram of a system 1600 for commercial activities in association with search engine 1100, in accordance with an embodiment. Note that in FIGS. 1-16 herein, identical or similar parts or elements are generally indicated by identical reference numerals. As indicated in FIG. 16, devices 1601 may be a computing device 900, kiosks 1300, 1400, cellular telephone 1001 and so forth may access a network 1030, such as, for example, the Internet or other appropriate networking entities (i.e., the World Wide Web). The search engine 1100 can be utilized through such devices to search for particular items, subjects, and so forth through the piction offerings provided by search engine 1100, as described herein (e.g., see FIGS. 1-8). A server 1606 includes or communicates with a database 1608 that includes information such as user profiles, applications with respect to various fields of use.

The server 1606 stores and processes a data brokering module 1607 that provides information to a customer based on what he or she has pictorially searched for through the search engine 1100. Note that the module 1607 is basically an application program such as the application programs 937 and/or program modules 938 depicted in FIG. 9. Recall that the basis for a search through search engine 1100 begins as a pictorial search that can be later enhanced with textual information. The data brokering module 1607 provides product offerings and ultimately data associated with the purchasing and delivery of products selected as a result of a search through the search engine 1100. Thus, for example, the search engine 1100 may be utilized to identify particular goods that can be purchased from a store 1604 and then delivered from a supplier 1602 to a user's home 1624.

While the present invention has been particularly shown and described with reference to embodiments or alternative embodiments, it will be understood by those skilled in the art that various changes in form and detail may be made therein without departing from the spirit and scope of the invention. Furthermore, as used in the specification and the appended claims, the term “computer” or “system” or “computer system” or “computing device” or “data processing apparatus” includes any data processing system including, but not limited to, personal computers, servers, workstations, network computers, main frame computers, routers, switches, telephones, and any other system capable of processing, transmitting, receiving, capturing and/or storing data.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A method of searching a network comprising a plurality of nodes interconnected via a link structure, said method comprising:
associating at least one pictogram with at least one node of said plurality of nodes;
searching said network such that a positive flow quantity and/or a negative flow quantity is propagated through at least one link of said link structure based upon a prior selection of said at least one pictograms; and
ordering said plurality of nodes based on a computed flow value resulting from propagation resulting from said positive flow quantity and/or said negative flow quantity.

2. The method of claim 1 further comprising decaying said positive flow quantity and/or said negative flow quantity as said positive flow quantity and/or said negative flow quantity propagates through said plurality of nodes.

3. The method of claim 1 further comprising utilizing a gaze tracking device to register selections of said at least one pictogram.

4. The method of claim 1 further comprising displaying said least one pictogram of said at least one node with a frequency based on a measured selection rate of said at least one pictogram.

5. A method of updating a link structure of a network, said method comprising:
recording a history of node selections to form a node path having nodes and links;
assigning a positive source flow and/or a negative source flow to target selected nodes of said node path;
computing steady state flow values through each link of said node path based on said positive source flow and/or said negative source flow; and
updating network links of said link structure of said network via said steady state flow values.

6. The method of claim 5 wherein each node of said node path leaks flow.

7. The method of claim 5 further comprising decaying each link of said link structure of said network.

8. The method of claim 5 further comprising utilizing a time interval to determine a value of said positive source flow and/or said negative source flow of said target selected nodes.

9. A system for searching a network comprising a plurality of nodes interconnected via a link structure, said system comprising:
a processor;
a data bus coupled to said processor; and
a computer-usable medium embodying computer code, said computer-usable medium being coupled to said data bus, said computer program code comprising instructions executable by said processor and configured for:
associating at least one pictogram with at least one node of said plurality of nodes;
searching said network such that a positive flow quantity and/or a negative flow quantity is propagated through at least one link of said link structure based upon a prior selection of said at least one pictograms; and
ordering said plurality of nodes based on a computed flow value resulting from propagation resulting from said positive flow quantity and/or said negative flow quantity.

10. The system of claim 9 wherein said instructions are further configured for decaying said positive flow quantity and/or said negative flow quantity as said positive flow quantity and/or said negative flow quantity propagates through said plurality of nodes.

11. The system of claim 9 wherein said instructions are further configured for utilizing a gaze tracking device to register selections of said at least one pictogram.

12. The system of claim 9 wherein said instructions are further configured for displaying said least one pictogram of said at least one node with a frequency based on a measured selection rate of said at least one pictogram.

13. The system of claim 9 wherein said instructions are further configured for:
decaying said positive flow quantity and/or said negative flow quantity as said positive flow quantity and/or said negative flow quantity propagates through said plurality of nodes; and
displaying said least one pictogram of said at least one node with a frequency based on a measured selection rate of said at least one pictogram.

14. The system of claim 9 wherein said instructions are further configured for:
utilizing a gaze tracking device to register selections of said at least one pictogram; and
displaying said least one pictogram of said at least one node with a frequency based on a measured selection rate of said at least one pictogram

15. The system of claim 9 wherein said instructions are further configured for:
utilizing a gaze tracking device to register selections of said at least one pictogram; and
decaying said positive flow quantity and/or said negative flow quantity as said positive flow quantity and/or said negative flow quantity propagates through said plurality of nodes.

16. A system for updating a link structure of a network, said system comprising:
a processor;
a data bus coupled to said processor; and
a computer-usable medium embodying computer code, said computer-usable medium being coupled to said data bus, said computer program code comprising instructions executable by said processor and configured for:
recording a history of node selections to form a node path having nodes and links;
assigning a positive source flow and/or a negative source flow to target selected nodes of said node path;
computing steady state flow values through each link of said node path based on said positive source flow and/or said negative source flow; and
updating network links of said link structure of said network via said steady state flow values.

17. The system of claim 16 wherein each node of said node path leaks flow.

18. The system of claim 16 wherein said instructions are further configured for decaying each link of said link structure of said network.

19. The system of claim 16 wherein said instructions are further configured for: employing a time interval to determine a value of said positive source flow and/or said negative source flow of said target selected nodes.

20. The system of claim 16 wherein said instructions are further configured for:
decaying each link of said link structure of said network; and
employing a time interval to determine a value of said positive source flow and/or said negative source flow of said target selected nodes.
